(19) United States
(12) Patent Application Publication
(10) Pub. No.: US 2010/0301196 A1
(43) Pub. Date: Dec. 2, 2010

(54) PORTABLE/MOBILE FISSIBLE MATERIAL DETECTOR AND METHODS FOR MAKING AND USING SAME

(76) Inventors: Wei-Kan Chu, Pearland, TX (US); Jia-Rui Liu, Pearland, TX (US)

Correspondence Address: ROBERT W STROZIER, P.L.L.C, PO BOX 429, BELLAIRE, TX, 77402-0429, US

(21) Appl. No.: 12/598,269

(22) PCT Filed: May 2, 2008
(86) PCT No.: PCT/US08/05718

§ 371 Date: Apr. 28, 2010

Related U.S. Application Data
(60) Provisional application No. 60/915,628, filed on May 2, 2007.

(51) Int. Cl. H05H 3/06; H01J 27/26; G01T 3/00; G01N 23/222

(52) U.S. Cl. 250/251; 250/423 F; 250/391; 977/949; 977/750; 977/752

(57) ABSTRACT

A portable and/or mobile detector for highly enriched uranium (HEU) and weapon grade plutonium (WGPu) is disclosed the detects HEU and/or WGPu based on neutron induced fission of a portion of the HEU and/or WGPu and detecting delayed neutron and/or γ-rays emission from delayed neutron emitters formed from the induced fission reactions.

### RELATED APPLICATION

This application claims priority to and the benefit of and is a 35 U.S.C. §371 National Phase Filing of PCT Application Serial No. PCT/US2008/05718, filed 2 May 2008 (May 2, 2008), which claims priority to and the benefit of U.S. Provisional Patent Application Ser. No. 60/915,628, filed 2 May 2007 (May 2, 2007).

### BACKGROUND OF THE INVENTION

1. Field of the Invention

The present invention relates to a fast/thermal neutron assessment (FTNA) technique for use in an active, mobile, flexible and non-interactive/nondestructive detection system to detect nuclear materials with high signal/noise ratio.

More particularly, the present invention relates to a fast/thermal neutron assessment (FTNA) technique, where the technique uses neutron generators based on a significant improvement of field ionization ion sources using Carbon Nanotubes (CNT) and different arrays of nano-tips. In field ionization, sharp tips, including film of CNTs and arrays of nano-tips can emit high current, and experiments on field ionization show high ion beam current density using CNT films at room temperature. High ion beam current of a several milli-Amps is the bases of the new neutron generator of this invention. Due to this simple field ionization ion source at room temperature, the neutron generator of this invention require low power, are lightweight and are small in size.

2. Description of the Related Art

The development of the nationwide and global nuclear detection architecture has become a critical problem for homeland security of US. The current fixed detector infrastructure for nuclear materials such as Highly Enriched Uranium (HEU) and Weapon Grade Plutonium (WGPu) is an ineffective, high cost and unreliable system, which leaves many loopholes.

Thus, there is a need in the art for an innovative technique for mobile and active nuclear detection systems with high performance and low cost, which can be integrated into small vehicles or airplanes, and used in a portal inspection network. Their preliminary results have shown that a large proton beam (2 mA/cm²) can be obtained by field ionization with carbon nanotubes. The neutron yield to be produced is 1000 times more than the best commercially available portable neutron generators, with better portability.

### DEFINITIONS

A nanotube (NT) is a small tube having a diameter between about 2 and about 1000 nanometers.

A multi-walled carbon nanotube (MWNT) is a collection of nested NTs, which share a common axis, i.e., they are tube within tubes.

A single-walled carbon nanotube (SWNT) is an NT comprising only one tube, shell or layer.

A carbon nanotube (CNT) is a nanotube comprising substantially elemental carbon.

A multi-walled carbon nanotube (MWCNT) is a collection of nested CNTs which share a common axis.

A single-walled carbon nanotube (SWCNT) is an CNT comprising only one tube, shell or layer.

NTs can either have a metallic or a semiconducting chirality. If (n−m)mod 3=0, the tube is said to have a metallic chirality; otherwise, the tube has semiconducting chirality. If n−m=0, the nanotube is called an armchair and is a true metal (0 eV bandgap). If n−m=q, where q is an integer, the nanotube is a semi-metal (milli eV bandgap). All other nanotubes are semiconductors, with a bandgap from 0.5 eV to 1.5 eV.

A surface modified nanotube (SMNT) are nanotubes that include one or a plurality of surface modifying agents bonded to the side wall or exterior surface of the nanotube.

A surface modified carbon nanotube (SMCNT) are carbon nanotubes that include one or a plurality of surface modifying agents bonded to the side wall or exterior surface of the nanotube.

### SUMMARY OF THE INVENTION

The present invention provides a mobile detection system and method for Highly Enriched Uranium (HEU) and Weapon Grade Plutonium (WGPu) based on delayed neutron and/or gamma ray detection using a neutron generator based on a field ionization source.

The present invention also provides an apparatus including metal tipped nano-structures as the ion emitter.

The present invention also provides an apparatus including a nano-material based ion emitter, an insulator, a plurality of resistors, secondary electron suppressors and a target, where the emitter is positioned to direct emitted particles at the target.

The present invention also provides a generator apparatus including a nanomaterials based ion emitter. The generator apparatus also includes insulators, a voltage-divider, a first resistor, a second resistor, a secondary electron suppressor and a target. The ion emitter comprises a thin film of nano-structures on a substrate. The emitter does not require a separate driving power supply such as hot filament or RF power supply. Only one high voltage (HV) power supply is needed for both the ion source and an accelerator portion of the apparatus. Due to this simplification, the power, size and weight of the new type of neutron generator can be dramatically reduced. The resistors are designed to adjust the voltage going to the emitter and to the accelerator.

The present invention also provides a fast neutron generator including an ion source of this invention connected via a cable to a power supply. The generator also includes a target, an inner shielding (such as a tungsten-type insulator), a middle shielding (such as an iron-type insulator), an outer shielding (such as an hydrogenous type insulator), and a neutron absorbent.

The present invention also provides a mobile fissile material detection station including a fast neutron generator of this invention, a mobile transport device (e.g., a land vehicle, a sea vessel, an aircraft, or any other motorized device), a neutron and/or γ-ray detector, an analyzer for analyzing neutron and/or γ-rays produced by directly a neutron flux from the neutron generator at an object, and a computer system adapted for data collection, storage, analysis, transmission, etc. and for command and control of the location and target object identification and for emergency management.

The present invention also a system for monitoring fissile materials, where the system include a plurality of neutron generators of this invention. The generators are mobile and distributed throughout an area or volume. The generators all include global positioning hardware and software as well as local computer software and hardware including communications hardware and software for wireless communication, tracking and monitoring by one or a plurality of central centers. The control centers monitor data received from the mobile generators and issued instructions for relocation. The area can be a land area, a sea area, a sea volume, an areal volume or a mixture thereof.

The present invention also a method for detection of fissile materials including the step of providing a neutron generator of this invention. The method also includes the steps of generating a neutron flux and directing the flux at an object to be analyzed and detecting generated neutron and/or γ-ray. The method also includes the step of analyzing the neutron and/or γ-ray to determine whether the emission profile is consistent with a fissile material. The method can also include the step of notifying appropriate authorities if a fissile material is detected.

The present invention also a method for implementing a network of mobile fissile material detection station including the step of providing a plurality of mobile fissile detection station including a neutron generator of this invention, a generated neutron and/or γ-ray detector, and an analyzer to analyze the detected generated neutrons and/or γ-rays. The method also includes the step of distributing the mobile units through an area or volume. The method also includes the steps of, for each station, generating a neutron flux and directing the flux at an object to be analyzed and detecting generated neutron and/or γ-ray. The method also includes the step of, for each station, analyzing the neutron and/or γ-ray to determine whether the emission profile is consistent with a fissile material. The method can also include the step of, for each station, notifying appropriate authorities if a fissile material is detected. The method can also include the step of redistributing the stations within the area or volume. The area or volume can be a land area, a sea area, a sea volume, an areal volume or a mixture thereof.

### BRIEF DESCRIPTION OF THE DRAWINGS

The invention can be better understood with reference to the following detailed description together with the appended illustrative drawings in which like elements are numbered the same.

FIG. 1A illustrates the energy level versus distance from solid surface for Field Emission of electrons.

FIG. 1A illustrates Field Ionization of the energy level versus distance of FIG. 1A.

FIG. 2A depicts field electron emission current I—Voltage dependence.

FIG. 2B illustrates the energy level versus distance from solid surface for field ionization.

FIG. 3 depicts a embodiment of an array emitter of this invention including a plurality of nano-tips.

FIG. 4 depicts a schematic drawing of an embodiment of a neutron generator of this invention.

FIG. 5 depicts calculated neutron yields.

FIG. 6 depicts a schematic drawing of an embodiment of a neutron source with neutron generator of this invention.

### DETAILED DESCRIPTION OF THE INVENTION

The inventors have found that an innovative technique for a high performance, low cost and mobile nuclear materials detection system based on the gas field ionization by nano-materials can be developed and constructed. The system of this invention includes: 1) identification of nanomaterials capable of gas field ionization; 2) fabrication of nano field ion emitters with different materials and nanostructures; 3) design, construction and testing of high yield portable neutron generators; and 4) design, construction and testing of mobile nuclear detection systems for HEU and WGPu detection.

The technique is based on a specific physical process in nuclear fissionable materials, but not in other radioactive materials. Some radioactive fission products are neutron and/or gamma ray emitters providing specific marks of fissionable material, so that detection of nuclear materials by these delayed neutrons can avoid the interference from gamma ray background in rocks, ceramics or concrete and medical or industrial radiation sources. The apparatus is especially well suited for detecting highly enriched uranium (HEU) and weapon grade plutonium (WGPu).

The neutron generators of this invention are portable and give the neutron yield higher than the existing commercial portable neutron generator by 2-3 orders of magnitudes. The portable neutron generators of this invention are important for homeland security applications, such as stand-off or remote detection of weapon-grade-uranium, explosives and other objects.

### Suitable Materials

Suitable nanotubes include, without limitation, non-metal nanotubes such as carbon nanotubes, boron-nitride nanotubes, silicon nanotubes, or the like and metal nanotubes such as gold nanotubes, gold alloy nanotubes, silver nanotubes, silver alloy nanotubes, or the like or mixtures or combinations thereof. Although the present compositions and methods are particularly suited to SWNTs, surface modification can be applied to all nanotube materials including, but not limited to, carbon nanotubes, single walled carbon nanotubes (SWCNTs), multi-walled carbon nanotubes (MWCNTs), single-walled and multi-walled boron nitride nanotubes, single-walled and multi-walled metals nanotubes, single-walled and multi-walled silicon nanotubes, single-walled and multi-walled metal silicides nanotubes, and other known nanotubes or mixtures or combinations thereof. Exemplary example include binary group II/V materials (GaAs, GaP, InAs, and InP), ternary III/N materials (GaAs/P, InAs/P), binary IINI compounds (ZnS, ZnSe, CdS, and CdSe), and binary SiGe alloys or mixtures or combinations thereof.

### Introduction

Recognizing the threat of nuclear terrorism, the development of nationwide and global nuclear detection architecture becomes a critical problem for the homeland security of the United States. The current trend toward a fixed detector infrastructure is an ineffective, high cost and unreliable way with many loopholes. However, the government cannot wait for perfect commercial equipment, so research on high performance nuclear detection technique is an urgent scientific task. In order to solve these problems, we will develop an innovative technique for mobile and active nuclear detection systems with high performance and low cost, which can be integrated into small vehicles or airplanes. The system can also be constructed to be portal. Thus, the application also envisions a system of portable inspection station forming an inspection network throughout the country.

This technique uses an interdisciplinary approach based on a fundamental mechanism of gas field ionization on nano-materials. The present invention is also related to a new class of high beam current ion sources and consequent high yield portable neutron generators.

Both field emission and field ionization are quantum tunneling processes of electrons in the presence of a high electric field, which can be obtained at sharp tips (confined or constrained to occur at sharp tips), where the tips have a small radius of curvature. In certain embodiments, the radius of curvature is on the order of nanometers. Field emission is a process in high vacuum, and is independent on temperature. Field ionization is a process in a deluted gas and is favorable to work at low temperature for a better gas supply. Gas field ionization at low temperature has been a long term research topic with a series of potential applications.

However, gas field ionization at room temperature has never been explored to a significant extent. The present invention is directed to a systematic study of field ionization at room temperature as a function of nano materials, nano geometries, solid state properties, gas pressures and external electric fields, etc. Our preliminary experimental results demonstrate field ionization of hydrogen on carbon nanotubes films. Based on the obtained ion beam current of several mA, the estimated D-T neutron yield for conceptual design of a portable neutron generator is 1000 times higher than present portable neutron generators, while having greater portability. A comparison of current portable neutron generators and an apparatus of this invention is shown in Table 1.

TABLE 1
Comparison of Prior Art Generators and Current Generator

| | D⁺ current | | Neutron yield | | Power | Portability |
|---|---|---|---|---|---|---|
| MP320 | 60 | μA | 10×⁸ | n/sec | 50 W | Yes |
| D711 | 0.5-3 | mA | 2 × 10¹⁰ | n/sec | 2000 W | No |
| Unit of this | 10 | mA | 1 × 10¹¹ | n/sec | 1000 W | Yes |
| Invention | | | | | | |

Due to the simplicity of the ionization & acceleration in the generators of this invention, the power consumption, weight, size of the generators of this invention are at a portable level. The neutron yield is comparable to or even higher than the current neutron source based on big cyclotron or electron linear accelerator of 10-100 MeV electrons.

### Research Objectives

To develop an innovative technique for a mobile nuclear materials detection system based on gas field ionization of nano-materials.

### Fundamental Study on Gas Field Ionization on Nanomaterials at Room Temperature

We studied the gas supply problem at room temperature, effects of different nanomaterials with different structures on the gas supply, field ionization and the stability. The nanostructure stability under high electric field of 107 V/cm to 108 V/cm was also studied.

### Fabrication of Nano Field Ion Emitters

We fabricated nano field ion emitters with different materials (e.g., nanotubes including carbon nanotubes and metals) and structures (e.g., density, tip geometry, spacing and height). These nano field ion emitters were used to study the field ionization response of various designs and to select suitable nanostructures for the apparatus of this invention.

### Construction of a High Yield Portable Neutron Generator

We constructed a portable neutron generator with much low power consumption and neutron yield thousands of times higher than present commercial units.

### Development of Mobile Nuclear Detection Systems

We developed a mobile nuclear detection system with a high yield neutron generator integrated into a well-designed collimator. Both delayed neutron and delayed γ-ray were used for Interrogation of Highly Enriched Uranium (HEU) and Weapon Grade Plutonium (WGPu) in different surroundings and environments, heavy metals or hydrogenous.

### Novelty and Significance

The technique of this invention offers significant advantages over commercially available techniques including, at least: (1) use of nano-materials as field ionization sources or emitters, such as carbon nanotube arrays, carbon nanowires and nano-tip arrays; (2) design, construction and testing of novel portable neutron generators having record high neutrons yields (e.g., 10¹¹ n/sec); (3) design, construction and testing of low cost, mobile nuclear detection systems using the portable neutron generators and corresponding portable collimators.

This mobile nuclear detection systems will have significant impact on the nationwide or global nuclear detection architecture, because mobile and active nuclear detection systems are now possible and a network of portable inspection stations can be deployed. The performance of nuclear detection systems will be enhanced significantly: (1) effective blockage of the existing loopholes in present nuclear detection network, where the current cumbersome detection system, it is difficult to follow a suspected object agilely, but the mobile system can solve the problem effectively; (2) enhanced sensitivity due to the short distance between the detected object to the neutron source and the detector. In active nuclear materials detection, the efficacy enlargement by increasing the solid angle is proportional to (R/r)⁴, where R and r is the long distance and short distance respectively. When both the source and detector distance is shorted by a factor of two, the efficiency is enhanced by a factor of 16; (3) the cost of the nuclear detection network will be significantly reduced due to the mobile detection systems itself and reduction of the number of postal inspection stations. The mobile detection system in conjunction with portal stations will significantly enhance the performance of the entire nuclear detection network.

### Fundamental Study of Field Ionization on Nanomaterials at Room Temperature

Background of Field Emission and Field Ionization

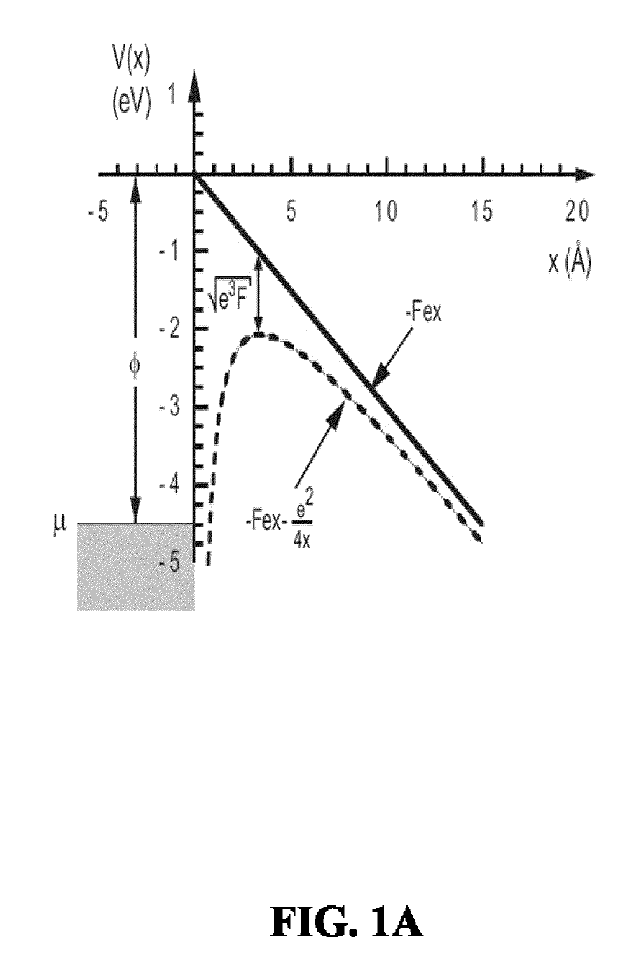

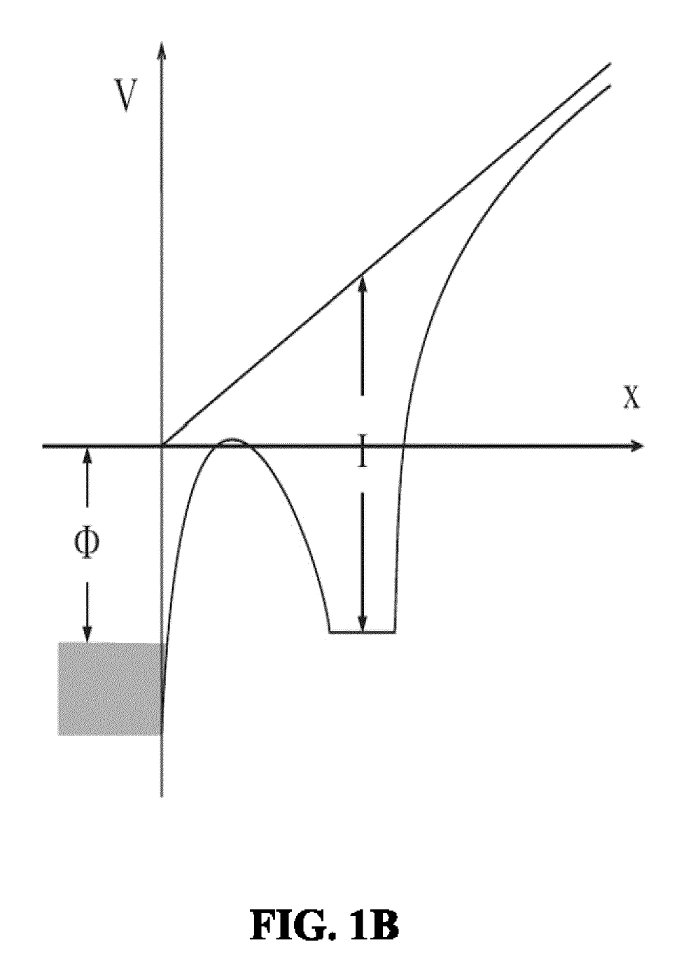

Field Emission is an electron emission process from a conducting surface into a vacuum in the presence of a high electric field, when the conductor is negatively biased. It is a quantum tunneling process whereby the electrons “automatically” tunnel through rather than jump over the Coulomb barrier as in photo-electron or thermionic electron emission. Field emission is illustrated in FIG. 1A and described by Equation (1), which is Fowler-Nordheim Equation [1].

Referring now to FIGS. 1A&B, the ion of energy level versus distance from solid surface for Field Emission of electrons (left) and Field Ionization (right) conforms to Equation (1):

$$J = \frac{{AE}^{2}}{φ} exp ( \frac{- B {φ}^{3 / 2}}{E} )$$

where: J is the ion current, E is the electric field, (1) is the work function of the metal, A and B are constants depending on the material.

Recently, due to the rapid development of nano-materials research, field emission based on nanostructure has been well studied and developed for many applications, such as flat-panel displays [2, 3], X-ray machines [4], high brightness electron sources [5] and gas sensors [6].

Field Ionization, illustrated in FIG. 1B, is a phenomenon occurring when a conductor is positively biased. When a gas molecule is near the surface, valance electrons of the gas molecules can tunnel into the solid surface and produces a positive ion, which is accelerated toward the cathode. Field ionization is described by Equation (2):

J=2pr⁻²X_{c}(T_{g}/Tₜ)^{1/2}C_{g}^{t-1}exp(−V(e)/KT_{g})

where r is the radius of curvature of the tip, X_{c}=(I-Φ)/Φ in cm, I is ionization potential of the molecule, Φ is the work function, F is the kinetic energy, T_{g} is the gas temperature and Tₜ is the tip temperature and C_{g} is the gas concentration.

The ionization current at room temperature is less than the current at LN temperature by about 2 orders of magnitudes. Field ionization was used in field ion microscopy (FIM) [7], and field ionization mass-spectrometry (FIMS) [8]. Deuterium ion beam of 4 nA by single W-tip field ionization was obtained in ‘Desktop Fusion’ at low temperature [9]. A later attempt by 50,000 W-tips array found the ion beams ‘were obscured’ at room temperature and no beam current was measured quantitatively [10]. There is practically no knowledge of Field Ionization studies on nano surface structures. In one embodiment of this invention, carbon nano-tubes (CNT) and metal nano-tip arrays are used to increase the ion current at room temperature.

### Experiments of the Invention

A randomly oriented carbon nanotubes thin film was used as field emitter. To avoid possible discharge in a deluted gas, the anode-cathode gap was increased to a few mm to 1 cm instead of a few hundreds μm gap as in conventional field emission measurement.

### Field Emission Measurement

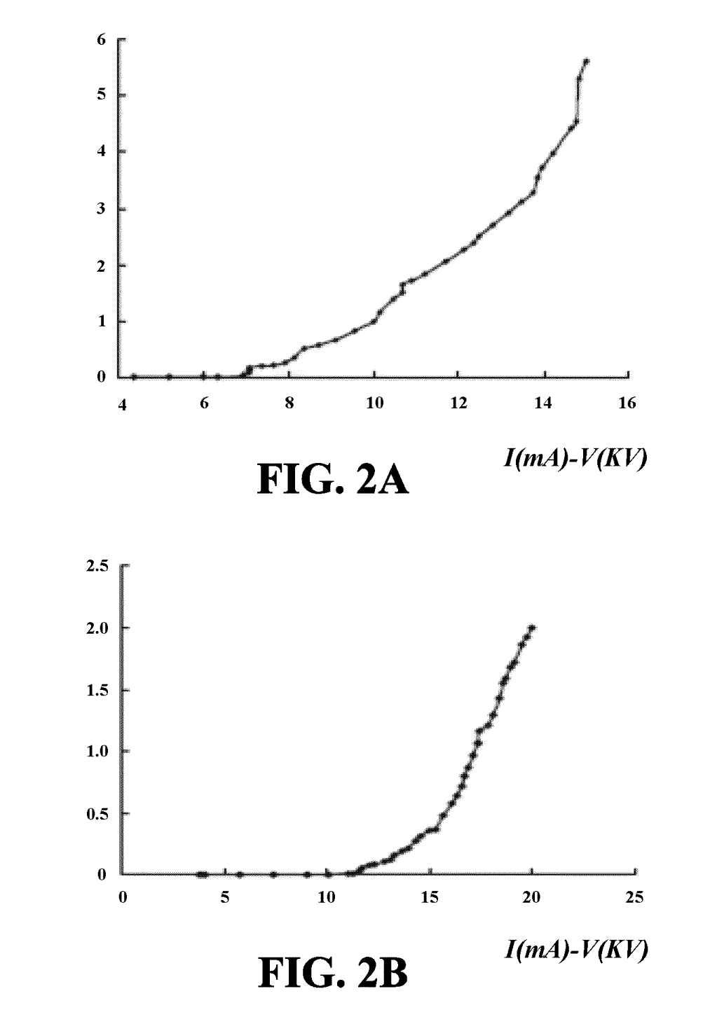

A field emission measurement in a high vacuum was performed first when the film of CNT was biased negatively. The field emission electron current and applied voltage was recorded, as shown in FIG. 2A. A plot of log I/V2 versus 1/V from experimental data gave a virtually straight line or Fowler-Nordheim dependence, which is evidence of quantum tunneling nature of the process. FIG. 2A depicts field electron emission current I—Voltage dependence. FIG. 2B depicts field ionization current I—Voltage dependence in hydrogen gas at a pressure of 10⁻⁴ Torr. The measured I value was limited by a chamber insulation problem.

### Field Ionization Measurement

When the film of CNT was biased positively in a vacuum, the energy level at the surface increased with distance, so the electron could not tunnel through. As the voltage was increased, no current appeared. When the chamber was filled with low pressure H₂ gas by adjusting a leak-valve and when the pressure reached about 10⁻⁴ Torr, a H ion current appeared. Maintaining the gas pressure well below the discharge threshold allowed the IN curve to be measured, as shown in FIG. 2B. Again, a plot of log UV' versus 1/V, showing Fowler-Nordheim dependence, provided evidence of the quantum tunneling nature of the ionization, but not gas discharge.

We previously demonstrated that an H ion current of 2 mA can be obtained from a 1 cm² film of nanotubes at room temperature. The measurement of current was limited by the insulation of the chamber, so the achievable currents should be larger than the measured values.

The several mA D ion beam current from 1 cm² field emitter provides an opportunity to develop high yield neutron generator up to 10″ n/sec [11]. Based on this type of non-focused ion source many additional important applications can be realized such as space propulsion ion thruster at the level of Kauffman ion thruster [12], and large area ion beam modification of materials by gas ions at the level of MEVVA ion source for metals. [13].

### Implication of Our Preliminary Data

We have demonstrated that ion beam current of several mA can be obtained from a 1 cm² nano-material field emitter. If we use deuterium gas instead of hydrogen gas, a 2 mA of deuterium ions was generated and a neutron yield of 10″ n/sec was produced. This neutron yield is 3 orders of magnitude higher than the best portable neutron generators available today. The power consumption, weight, size and cost of the generators or this invention are much better than existing portable neutron generators.

### Fundamental Study on Field Ionization of Nanostructures

The progress of nanomaterials and nanotechnology provided new opportunities in gas field ionization study and its applications in ion source developments. By using an enormous number of very sharp nano-tips, ion current enhancements compensate for a negative temperature effect and provide large total ion current.

### Temperature Effects on Gas Field Ionization

The gas field ionization showed strong temperature dependence. At low temperature, a thin gas layer is condensed on the metal surface, so the gas supply for the ionization at the tip is improved. When the temperature is increased, the field ionization current decreases due to poor gas supply without the condensate layer. The field ionization current at room temperature is less than that at LN temperature by 2 orders of magnitude. Moreover, a field ion emitter will have a temperature instability problem.

### Field Ionization on Various Nano-materials and Optimization

Field ionization was measured at HV with large anode-cathode gap, to avoid the effect of nanostructure instability. We measured the field ionization on different nanomaterials (random CNTs, CNTs array and metal nano-tip array) and different structures (density, tip geometry, and spacing, height). The field emission was measured first to check the property of the nanomaterials. I/V curves were measured with positive and negative biases. For different nanomaterials, their structures were optimized for the best field ionization effects. The film with superior field ionization properties were selected and confirmed with He gas ionization. Finally, field ionization measurements were conducted in Hydrogen gas and the best film were selected for each group.

### Long Term Stability of the Field Ionization

We tested pressure dependence of the ionization current for each group of films. The secondary electron contribution was measured separately by ion beam bombardment with an ion implanter of the same energy, but the final measurement were performed with an additional electrode for secondary electron suppression by −300V. The selected films were measured at 100 kV with different gaps and insulators. The parameters of the final measurement at HV of 100 kV was used for neutron generator design.

### Fabrication of Nano Field Ion Emitters

The fabrication and assembly of the uniform nano-tip arrays will be conducted by Cheng's group at Nanotechnology Manufacturing Research Laboratory at University of Houston. The general goal of nanomaterial processing team is to fabricate different field ion emitters with different materials (CNTs and metals), and structures (density, tip geometry, and spacing, height). These nano-tip arrays will be used to study the field ionization response of various designs to select the suitable nanostructures for the apparatus of this invention. The following nanostructures are well suited for use in this invention.

### Fabrication Random CNTs on Metal Substrate

Carbon nanotubes (CNTs) have been known as an efficient field emitter because of their chemical stability, thermal stability, high electrical and thermal conductivity, very high aspect ratio for field enhancement and small tip diameter [14,15]. The fabrication of CNTs has been extensively studied. However, the studies on direct assembly of CNTs on metal substrates are limited. Screen-printing with CNT paste has been widely used. In this approach, CNT paste (a mixture of inorganic binders, metal particles, and CNT powder) is pressed onto a fine metal mesh placed on a substrate [16, 17]. A subsequent burning process is used to remove some organic particles and to promote adhesion of CNTs to the substrate. However, the organic binders on the metal cathode after burning continually outgas, which induces severe degradation of the tip by oxidation. In addition, weak adhesion of CNTs to the substrate often leads to a catastrophic vacuum breakdown or arcing [18]. In this study, a uniform layer of CNTs will be assembled on metal substrate to form a strong adhesion between the CNTs and substrate.

### Fabrication Process

1) Thin multi-walled CNTs will be grown by catalytic chemical vapor deposition (CVD). The fabrication procedure has been described elsewhere [19, 20]. The mean diameter of thin MWCNTs is approximately 5 nm with 3-5 carbon layers. 2) A metal (In) layer (˜100 nm) will be deposited on tin-oxide plate using a thermal evaporator. Indium is chosen for the adhesive metal layer because of its low melting temperature and good sinterability. 3) The thin MWCNTs will be dissolved in 1,2-dichloroethane (DCE) and sonicated to debundle them, followed by centrifugation. Then the dispersed CNT will be sprayed as a solution over the substrate. Since DCE is a highly volatile, no heating system is needed to evaporate it on the substrate. 4) CNTs on substrate will be thermally annealed at 300-4000 C in ambient Ar for 10 min to induce strong adhesion of the CNTs with the substrate. 5) Because CNTs on the topmost layers are weakly bound to the substrate through tube-tube contacts, the excess tubes will be removed using a sticky tape. This process is also necessary to induce preferential alignment of tubes perpendicular to the substrate.

### Fabrication Aligned CNTs Array

It is well-known that closely packed CNTs are not effective field emitters due to the field screening effects among neighboring tubes. [21] have shown that in order to minimize field screening effects, each and every nanotube should be spaced apart by twice their height. In this study, the density and aspect ratio of the CNTs array will be changed to maximize the field ionization effects. Fabrication methods will be developed to make patterned and aligned CNTs with uniform structures and periodic arrangements to meet device requirements.

There are a few conventional methods for fabricating patterned aligned CNT arrays. One is by means of growth on a patterned catalyst layer whereby the surface of a substrate is first covered with a mask and then deposited with catalytic nanoparticles from which the nanotubes can grow [22, 23, 24]. Another technique makes use of electron beam lithography to define the patterns of catalytic nanoparticles for the growth of CNTs [25]. In this study, aligned multiwalled CNTs of uniform length will be grown on the substrates. Silicon substrate will be coated with a thin layer of sputtered titanium (20 nm), followed by photoresist deposition and patterning with e-beam lithography to define the catalyst sites. Then cobalt (Co) catalysts (5-10 nm) will be deposited using DC magnetron sputtering. Following that, the unwanted catalysts on the photoresist will be removed by an acetone lift-off technique. The Ti layer acts both as a conductive layer and a diffusion barrier layer to prevent the formation of cobalt silicide. Finally, plasma-enhanced chemical vapour deposition (PECVDa will be used to grow CNTs under a reactant gas flow (C₂H₂/H₂ or C₂H₂/NH₃) at around 750° C., 1200 mTorr and a DC plasma of 100 W.

### Fabrication of Metal Tip Arrays

Metal tips (W, Ir) have been widely used in vacuum-based electronics, such as field-electron emission (FE) cathodes. These cathode structures have been fabricated by several methods. The original Spindt technique involves the vapor deposition of the cone material through a hole of decreasing diameter [26, 27]. This technique, or slight variations on it, is predominant in the VME area. Other techniques of field-emitter array fabrications involve 1) isotopic or anisotropic etching of single-crystal material (silicon) or thin films, 2) mold and casting processes, and 3) directional solidification. A large variety of material can be used to form the emitting cones, either by vapor or sputter deposition. Molybdenum and Tungsten are commonly employed because of their ready compatibility with other procedures involved in their high temperature stability, good electrical and thermal conductivity.

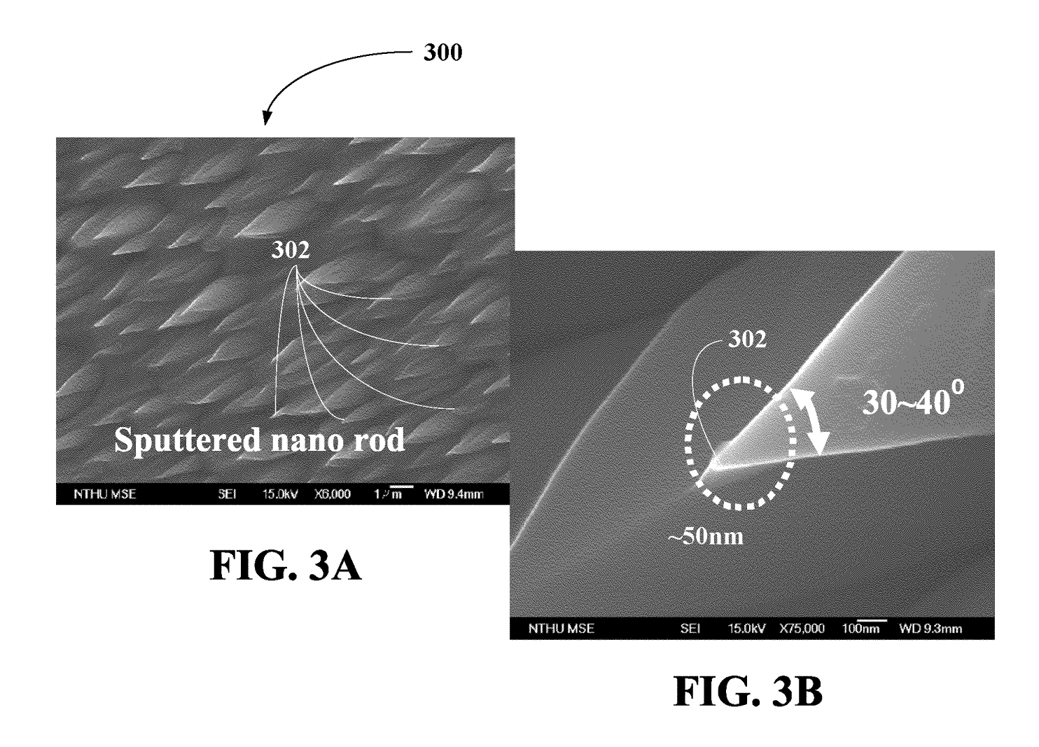

Although the metal tip array structure in FE cathodes has been studied extensively, those fabrication processes are complicated and expensive. More importantly, the FE electrode structure is not suitable for field ionization (FI) cathodes. In this study, an innovative and low cost approach will be employed to fabricate the metal tip array. This approach in FIG. 3 shows the fabrication process. Step (a): A silicon wafer is thermal oxidized to have ˜100 nm SiO₂ thin film. Photoresist (PR) will be sprayed on SiO₂. The RP are patterned by UV-lithography to form arrays of squares. The size of the squares are from 1×1 μm to 10×10 μm, depending on the required density. The exposed SiO₂ will be dry etched by Reactive ion etching (RIE). The silicon wafer (single crystal) will be wet-etched to form an array of sharp-tip holes. The PR and SiO₂ will be removed by acetone and HCl respectively. Step (b): A tungsten thin film (˜10˜50 nm) will be deposited in the silicon holes using DC magnetron sputtering. Step (c): The abovementioned structure will be bonded with a metal plate (W or Mo) using thermal fusion bonding in ambient Ar at ˜1000° C. Step (d): The tungsten nano-tip array will be released by wet etching silicon using KOH at 80° C. Because the tip of the wet etched silicon holes (in step a) is very sharp at atomic scales, the conformal tungsten tip is also very sharp (radius 1˜5 nm).

Referring now to FIGS. 3A&B, an embodiment of a fabricated nano field ion emitter, generally 300, is shown to include a plurality of tips 302. Looking at FIG. 3B, an expanded view of a single tip 302 is shown encircled and its dimension are indicated.

### Construction of a High Yield Portable Neutron Generator

One of the novelties of this invention is the construction and testing of a neutron generator using optimized nanomaterials. The prototype was operated with deuterium gas for ion ionization and used Tritium loaded titanium (Ti-T) targets or Deuterium load titanium (Ti-D) targets. While tritium and deuterium loaded titanium targets have been disclosed, other target can be used as well, especially, other metal loaded tritium or deuterium loaded targets including those disclosed in U.S. Pat. No. 3,683,190 (incorporated by reference per the global incorporation by reference statement at the close of the detailed description), ScT₂ and ScD₂ targets, tritium and deuterium loaded aluminum, gold, palladium, palladium-silver mixed metals, as well as any other metal or film capable of absorbing tritium and deuterium. The portable neutron generators of the invention are based on low energy D-T or D-T nuclear reactions:

D+D→n+3He+3.28 MeV

D+T→n+4He+17.6 MeV

These nuclear reactions have large cross sections at relatively low energy (100 keV), compared with neutron sources with electron accelerators or ion cyclotron of 10 s MeV. The neutron generators operating at such low ion energy can be portable. Present commercial portable neutron generator model MP-320 from Thermo-Electron weighs 12.5 kg with power consumption of 50 W. The maximum yield is 10⁸ n/sec. To increase the neutron yield up to 10¹° n/sec, the ion energy needs to be increased due to ion beam current limitation of the plasma-type ion source. High neutron yield generators are available bu weigh thousands of kgs. The neutron generator of this invention based on a field ionization ion source can represent a revolutionary advance in neutron generator development. In this type of neutron generators, no high power ion source is needed.

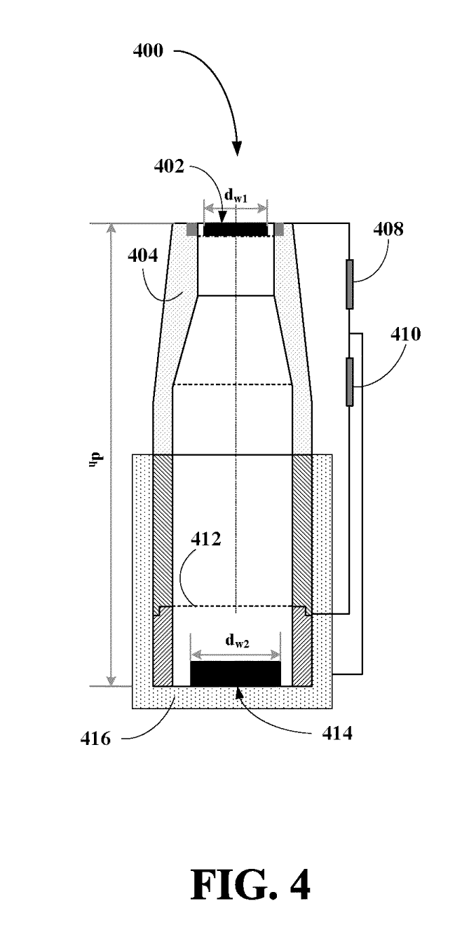

Referring now to FIG. 4, a schematic drawing of an embodiment of a thermal neutron collimator for a neutron generator of this invention, generally 400, is shown to include a nanomaterials based ion emitter 402. The collimator 400 also includes insulators 404, a high voltage power supply 406, a first resistor 408, a second resistor 410, a secondary electron suppressor 412, a Ti-T target 414 and a cooling sleeve 416 filled with a coolant. The ion emitter 402 comprises a thin film of nano-structures on a substrate. The emitter 402 does not require a separate driving power supply such as hot filament or RF power supply. Only one high voltage (HV) power supply 406 is needed for both the ion source 402 and an accelerator 418. Due to this simplification, the power, size and weight of the new type of neutron generator 400 can be dramatically reduced. The resistors 408 and 410 are designed to adjust the voltage going to the emitter 402 and to the accelerator 416.

The height of the collimator 400 has a height, excluding the cooling sleeve, having a value dₕ. The height dₕ generally is a value between about 6″ and about 12″. In certain embodiments, the height dₕ generally is a value between about 7″ and about 10″. In other embodiments, the height dₕ generally is a value between about 7″ and about 9″. In other embodiments, the height dₕ generally is a value of about 8″.

The emitter diameter d_{w1} is generally between about 0.5″ and 2″. In certain embodiments, the diameter d_{w1} is generally between about 0.5″ and 1.5″. In other embodiments, the diameter d_{w1} is generally between about 0.75″ and 1.25″. In other embodiments, the diameter d_{w1} is generally about 1″.

The target diameter d_{w2} is generally between about 1″ and 3″. In certain embodiments, the diameter d_{w2} is generally between about 1.5″ and 2.5″. In other embodiments, the diameter d_{w2} is generally about 2″.

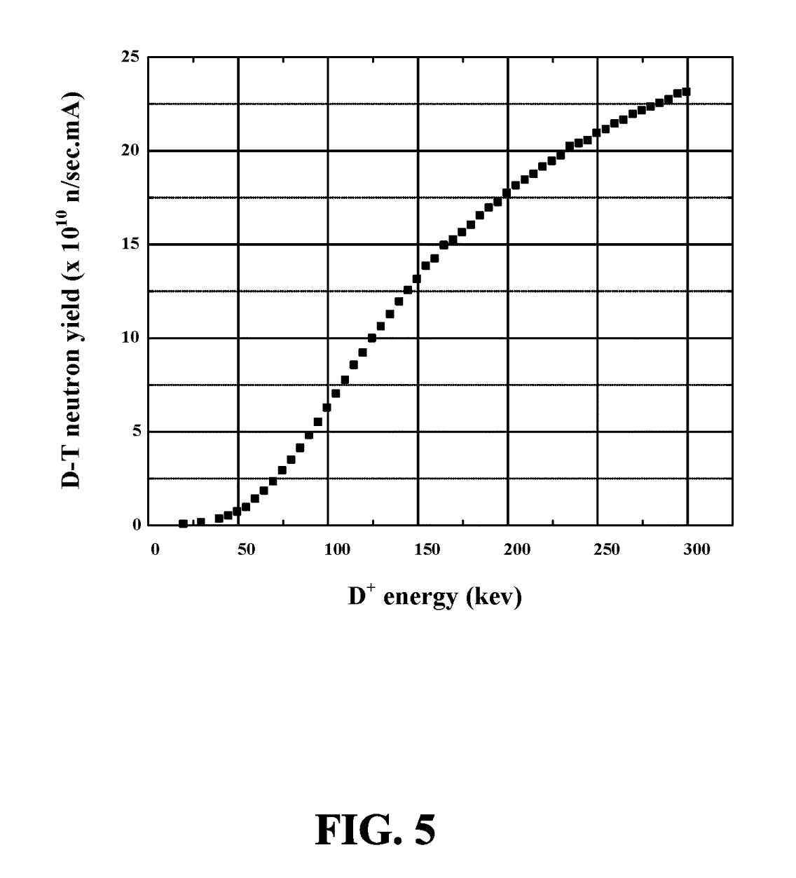

The results of this design are low cost, simplicity for applications and compatible for many mobile applications. In our case, when the D ion beam current is several mA at 100 keV, an estimated neutron yield of 10¹¹ n/sec is generated. The estimation is based on calculated neutron yields as shown in FIG. 5.

Mobile detection systems for interrogation of HEU and WGPu
Background—Current Problems with Nuclear Materials Interrogations

Nuclear terrorism became a major threat to the United States after the break-up of the former Soviet Union. Since only about 15 kg weapon-grade uranium (>93% U-235) is needed for a crude nuclear bomb, nuclear attack is a real threat. The major reason of the trafficking incidents involving weapon-usable nuclear fissionable materials is the limited prevention of illegal border crossing due to the inadequate and old equipment for radioactive materials detection and inspection.

The major problems in existing fissionable materials detection techniques include:

### Postal Inspection Station

Postal inspection stations designed to screen cargo may suffice for guarding HEU in small nuclear facilities. But, unfortunately, on a national scale there are many loopholes for terrorists to find a way around it. Moreover, to set up an elaborate and nationwide network of screening stations could require extraordinarily costs but provide few security gains.

### Physical Limitation of Passive Detection Techniques

Most of the existing detection systems consist of passive detectors, which are confronted with some basic physical limitations such as: 1) small solid angle subtended by the detectors (˜distance⁻²). Postal screening station with fixed detectors can not reduce the distance to the objects. And 2) long detection time for adequate statistics due to their low sensitivity. Even when some handheld γ-detectors can be moved closer to the inspected item, the long data-collection time is still there due to the low efficiency of these small volume detectors.

### Radiography and Passive γ-Detectors are not Effective for HEU Detection

The postal screening station with radiography and fixed detectors mentioned above are necessarily and useful for inspection of legal transporting of goods with natural radioactivity, medical radioactive materials and etc., but they are not effective for illicit nuclear materials detection.

Radiography screening and passive detection of y-radiation are confronted with two physical limitations: the easy shielding of γ-radiation of U-235 with the energy of 185 keV and below (by a few mm lead and steel) and the universal natural y-background. In fact, many common imported goods are either intentionally or naturally radioactive with y radiation. Commercial ceramic-glazed materials, abrasives, road salt, and even kitty litter contain natural radioactivity, mainly γ-radiation. These natural radiations may trigger false alarms from radiation detectors. Moreover, medical radionuclide and industrial radiation sources, like Co-60 and Cs-137, are used throughout the world, so the problems of detecting illicit radioactive materials, including fissionable materials HEU and WGPu, with γ-detector is more complicated. The best way to solve this physical problem is to avoid passive γ-detection.

### Methodology

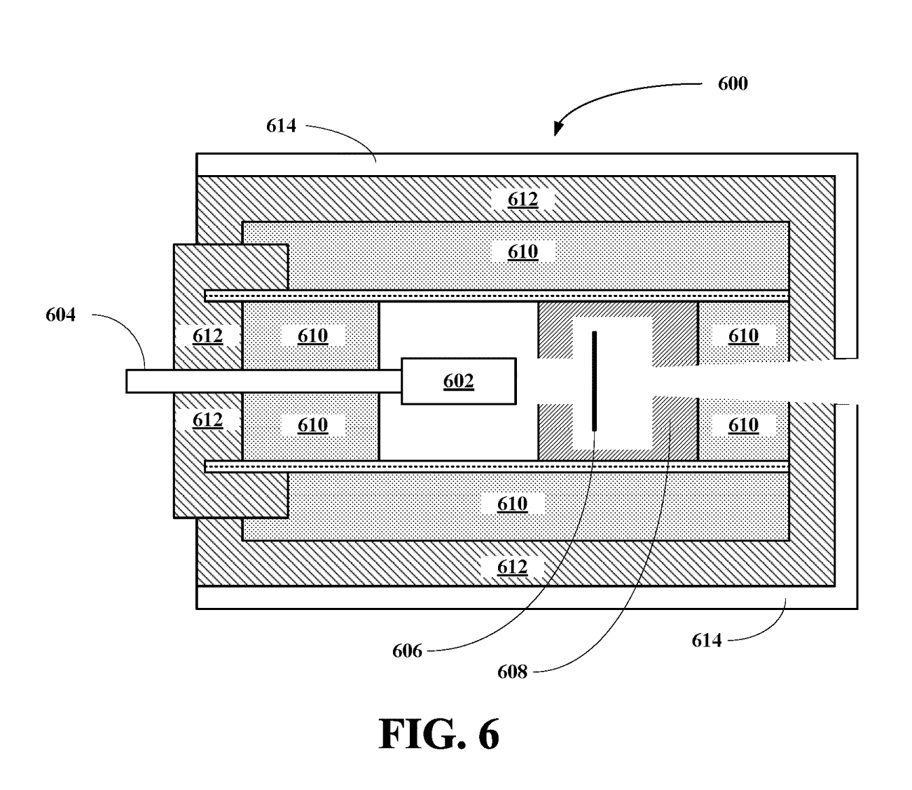

One embodiment of the neutron generators of this invention relates to a system for generating neutrons at high yield for use as a good penetrating probe for HEU and WGPu detection. The neutron source using the neutron generators of this invention can be used in different modes. One mode is the construction of a fast neutron source having a collimator as shown in FIG. 6. Looking at FIG. 6, an embodiment of a fast neutron generator, generally 600, is shown to include an ion source 602 connected via a cable 604 to a power supply not shown. The generator 600 also includes a Ti-T target 606 (other target can be used as well depending on the output desired). The generator 600 also includes an inner shielding 608 (e.g., tungsten-type), a middle shielding 610 (e.g., iron-type), an outer shielding 612 (e.g., hydrogenous type), and a neutron absorbent 614.

Another mode of applications is thermal neutron source with well designed moderator-collimator, which is more complicated, but using a nano-structured emitter of this invention. When neutrons are used as incident particles in fission reactions, both neutron and γ-ray reaction products can be used for U detection[28, 29]. The γ-quanta and neutrons from the fission reaction go through the surrounding materials and are then detected by the detectors. The choice of detected reaction products, γ-quanta or neutrons, depends on the surrounding materials. The penetration characteristics of γ-ray and fast neutrons in different materials are shown in Table 2.

TABLE 2
Penetration Characteristics of γ-ray and Fast Neutrons

| | Energy | Range (meter)* | | |
|---|---|---|---|---|
| | (MeV) | In water | In Aluminum | In Lead |
| γ-ray | 1 | 0.14 | 0.06 | 0.013 |
| Neutrons | 1 | 0.13 | 8.00 | 29.000 |

*γ-ray and neutron do not have well defined range. The table gives the average attenuation path length for y-ray and mean energy absorption length for neutrons.

When the surrounding materials are heavy metals, γ-rays will be attenuated much faster than neutrons, so the fission neutrons from the reaction can be detected with higher sensitivity. In the case of hydrogenous materials, such as juice and fruits, detection of γ-rays may be a better choice. A useful instrument must tolerate a broad range of conditions affecting the presence and quality of HEU signatures. In most cases, no single technique alone will suffice to reliably distinguish suspected items from inspected cargo, without a high rate of false positives. The high yield neutron generator gives different choices in different combinations to increase the probability of correctly identifying the interrogated objects.

### Delayed Neutron and Delayed Γ-Ray Detection

### Theoretical Background

During the fission process the ²³⁵U nucleus first absorbs a neutron, and a ²³⁶U compound nucleus is formed in an excited state and then decay by fission process. Some of the fission fragment with relatively longer half-life (0.23 sec to 57 sec) are decayed with n emission, which is delayed neutron. Among these fission neutrons, nearly 99% are prompt and about 1% are delayed neutrons. The fission process is described as follows:

U+n→X+Y+kn+Q

where X and Y are fragments nuclei, Q is the reaction energy. k is the average neutron yield per fission. For U, k=2.46. The neutron rich fragment nucleus will decay:

$${}_{Z}^{A}{X}{}_{N}^{b} \to {}_{Z + 1}^{A}{Y}{}_{N - 1}^{} \to {}_{Z + 1}^{A}{T}{}_{N - 2}^{} + n$$

where the “X” nucleus is called delayed-neutron precursor, the “Y” nucleus is called delayed-neutron emitter. Obviously, for these neutrons the “delay time” is determined by the half-life of the precursor nucleus (X). For U fission, there are six groups of delayed neutrons with six different half-lives from 0.23 to 57 sec. Delayed y-ray is from the same decay process.

### Experimental Procedure

For detection of a small quantity of U or Pu, background radiation is the main factor that needs to be considered The prompt γ-ray and neutrons are emitted during neutron bombardment, so the background of other γ radiation and scattered neutrons are very high, so the prompt γ-ray or neutron are not good candidates for U and Pu detection. The delayed neutron and delayed γ-rays can be detected when the incident neutrons are off and background radiation is low. Different combinations of delayed neutron or delayed γ-ray detection with fast neutron or thermal neutron probing beam can be used for U and Pu detection to get more successful detection.

The neutron generator is a switchable neutron source. When the neutron beam is on, the sample gets irradiated to cause fission reaction, fission fragments—delayed neutron emitter is accumulating and decaying, according to accumulation-decay curve, the accumulated amount of the precursor will be saturated at a certain fluence. When the neutron generator is off to stop the irradiation, after a little while, the delayed neutron will be counted for a certain duration. This cycle will be repeated to accumulate the statistics. The number of the detected neutrons is the signature of the quantity of fissionable material—U or Pu. The primary detector to be used is a specially designed long counter with ³He or BF₃ proportional counters. Since the proportional counter is insensitive to γ-ray, especially very hard delayed γ-ray, the discrimination of γ- and x-background will be perfect.

In the technique of delayed γ-ray detection, the experiment is handled in a similar way. The main difference is the huge number of delayed γ-quanta and the huge background. The primary γ-detector is large volume crystal scintillators or liquid scintillators.
The differences between delayed neutron and delayed γ-ray detection are as follows:
Delayed neutrons detection has less counts but with low background
Delayed γ-ray detection has very large counts but at high background.
The good statistics of delayed neutron detection is due to low background.
The good statistics of delayed γ-detection is due to huge numbers for subtracting the huge background.
The delayed neutron detection technique is more sensitive in heavy metal environment.
The delayed γ-detection is more useful in hydrogenous environment.

In most cases, a combination of the two techniques with high yield neutron generator with two sets of detectors will provide high performance. Therefore, one embodiment of the detectors of this invention include a delayed neutron detector and a delayed γ-ray detector.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

1. A field ionization ion source apparatus comprising a nano-material emitter including a nano-material film having a plurality of metal tips, where the emitter emits up to several mA/cm² of an ion current.

2. The apparatus of claim 1, further comprising a loading of tritium, deuterium or a mixture thereof.

3. The apparatus of claim 1, wherein the nano-material film comprises nanotubes.

4. The apparatus of claim 1, wherein the nanotubes are selected from the groups consisting of non-metal nanotubes, metal nanotubes, metal silicides nanotubes, alloy nanotubes, and mixtures or combinations thereof.

5. The apparatus of claim 1, wherein the non-metal nanotubes are selected from the groups consisting of carbon nanotubes, boron-nitride nanotubes, silicon nanotubes, and mixtures or combinations thereof.

6. The apparatus of claim 1, wherein the metal nanotubes are selected from the groups consisting of gold nanotubes, gold alloy nanotubes, silver nanotubes, silver alloy nanotubes, and mixtures or combinations thereof.

7. The apparatus of claim 1, wherein the nanotubes are selected from the groups consisting of single walled nanotubes, multi walled nanotubes, and mixtures or combinations thereof.

8. The apparatus of claim 1, wherein the carbon nanotubes are selected from the groups consisting of single walled carbon nanotubes (SWCNTs), multi-walled carbon nanotubes (MWCNTs), and mixtures or combinations thereof.

9. The apparatus of claim 1, wherein the boron-nitride nanotubes are selected from the groups consisting of single-walled and/or multi-walled boron nitride nanotubes.

10. The apparatus of claim 1, wherein the metal nanotubes are selected from the groups consisting of single-walled and/or multi-walled metals nanotubes.

11. The apparatus of claim 1, wherein the metal silicides nanotubes are selected from the groups consisting of single-walled and/or multi-walled metal silicides nanotubes.

12. The apparatus of claim 1, wherein the non-metal nanotubes are selected from the groups consisting of single-walled and/or multi-walled silicon nanotubes.

13. The apparatus of claim 1, wherein the alloy nanotubes are selected from the groups consisting of single-walled and/or multi-walled alloy nanotubes of binary group III/V materials (GaAs, GaP, InAs, and InP), ternary III/N materials (GaAs/P, InAs/P), binary IINI compounds (ZnS, ZnSe, CdS, and CdSe), and binary SiGe alloys, and mixtures of combinations thereof.

14. A mobile detector apparatus for fissile materials comprising:
a portable high yield neutron generator comprising a field ionization ion source comprising a nano-material emitter, where the generator has a neutron yield up to 10¹¹ n/sec at a voltage to 100 KeV, and
a neutron and/or γ-ray detector adapted to detect delayed neutrons and/or γ-rays generated by a fissile material upon irradiation by a neutron flux generated from the portable high yield neutron generator.

15. The apparatus of claim 14, wherein the fissile material is elected from the group consisting of highly enriched uranium (HEU), weapon grade plutonium (WGPu) and mixtures thereof.

16. A system for detecting fissile materials comprising:
a mobile transport vehicle,
a neutron generator disposed on the vehicle, where the generator comprises a metal tipped nano-material emitter including a nano-material film having a plurality of metal tips, and where the generator has a neutron yield up to 10″ n/sec at a voltage to 100 KeV, a neutron and/or γ-ray detector disposed on the vehicle and adapted to detect delayed neutrons and/or γ-rays generated by a fissile material in an object of interest upon irradiation by a neutron flux generated from the neutron generator, and a command subsystem disposed on the vehicle and including:
an analyzer adapted to analyze an output of the detector to determine the nature of the detected neutrons and/or γ-rays by the object, and
a processing unit adapted to collect, store, analyze data from the analyzer, to communicate the data to a command center, to receive commands relating to object identification, testing, and to implement emergency protocols if a fissile material is detected in the object of interest.

17. A method comprising the steps of:
directing a collimated beam of fast and/or thermal neutrons at an object to be inspected causing fission reactions of any highly enriched uranium (HEU) and/or weapon grade plutonium (WGPu);
detecting delayed neutrons and/or γ-rays emitted by the fission reactions; and
determining whether highly enriched uranium (HEU) and/or weapon grade plutonium (WGPu) is present in the object.

18. The apparatus of claim 1, wherein the nano-material emitter comprises an insulator, a plurality of resistors, and secondary electron suppressor, where the emitter is positioned to direct emitted particles at a target.

19. The apparatus of claim 1, further comprising a high voltage power supply.

20. The apparatus of claim 19, wherein the emitter is connected via a cable to the power supply, and the apparatus further comprises an inner shielding, a middle shielding, an outer shielding, and a neutron absorbent.

21. (canceled)

22. The system of claim 16, further comprising:
a plurality of neutron generators, where the generators are mobile and distributed throughout an area or a volume,
where each generator includes a global positioning hardware and software, local computer software and hardware including communications hardware and software for wireless communication, tracking and monitoring by one or a plurality of central centers, where the control centers monitor data received from the mobile generators and issued instructions for relocation and where the area or volume is selected from the group consisting of a land area, a sea area, a sea volume, an areal volume or a mixture thereof.

23. A method for detection of fissile materials comprising the steps of:
providing a neutron generator comprising a nano-material emitter including a nano-material film having a plurality of metal tips, where the emitter emits up to several mA/cm² of an ion current;
generating a neutron flux and directing the flux at an object to be analyzed;
detecting neutrons and/or γ-rays generated by the object;
analyzing the neutron and/or γ-ray to determine whether the emission profile is consistent with a fissile material; and
notifying appropriate authorities if a fissile material is detected.

24. A method for implementing a network of mobile fissile material detection station comprising the steps of:
providing a plurality of mobile fissile detection stations, each station including:
a neutron generator of comprising a nano-material emitter including a nano-material film having a plurality of metal tips, where the emitter emits up to several mA/cm² of an ion current;
a neutron and/or γ-ray detector;
an analyzer to analyze the detected neutrons and/or γ-rays;
distributing the mobile units through an area or a volume, where the area or volume is selected from the group consisting of a land area, a sea area, a sea volume, an areal volume or a mixture thereof;
for each station, generating a neutron flux and directing the flux at an object to be analyzed and detecting neutrons and/or γ-rays generated by a fissile material;
for each station, analyzing the neutrons and/or γ-rays to determine whether the emission profile is consistent with a fissile material.

25. The method of claim 24, further comprising the step of:
for each station, notifying appropriate authorities if a fissile material is detected.

26. The method of claim 24, further comprising the step of:
redistributing the stations within the area or volume.

27. The apparatus of claim 1, wherein the emitter comprises insulators, a first resistor, a second resistor, and a secondary electron suppressor, where the emitter is positioned to direct emitted particles at a target.

28. The apparatus of claim 19, wherein the emitter comprises insulators, a first resistor, a second resistor, and a secondary electron suppressor, where the high voltage power supply supplies power to both the emitter and the accelerator portion, where the resistors are designed to adjust a voltage going to the emitter and to the accelerator and a power, size and weight are reduced relative to current generators.

29. The apparatus of claim 1, wherein the emitter comprises a thin film of nano-structures on a substrate.

30. The apparatus of claim 19, wherein the emitter comprises a thin film of nano-structures on a substrate.
